(19) United States
(12) Patent Application Publication
(10) Pub. No.: US 2012/0012232 A1
(43) Pub. Date: Jan. 19, 2012

(54) METHOD AND APPARATUS OF FRICTION WELDING TO INCREASE TENSILE STRENGTH OF WELDED WORKPIECE

(75) Inventors: Koichi KAWAURA, Aichi-ken (JP); Akira MIZUTANI, Aichi-ken (JP)

(73) Assignees: IZUMI MACHINE MFG. CO., LTD., Aichi-ken (JP); KABUSHIKI KAISHA TOYOTA JIDOSHOKKI, Aichi-ken (JP)

(21) Appl. No.: 13/240,961

(22) Filed: Sep. 22, 2011

Related U.S. Application Data
(62) Division of application No. 12/415,192, filed on Mar. 31, 2009.

(30) Foreign Application Priority Data
Apr. 1, 2008 (JP) 2008-094930

(51) Int. Cl. B23K 31/02; C21D 1/42; B23K 20/12

(52) U.S. Cl. 148/526; 228/114.5

(57) ABSTRACT

A friction welding method includes a step of friction welding a first workpiece and a second workpiece together by pressing the first workpiece against the second workpiece relatively while rotating the two workpieces relatively, and a step of annealing the friction welded workpiece at a position adjacent to a welded portion thereof with high frequency induction heating. A friction welding apparatus is provided for friction welding a first workpiece and a second workpiece together by pressing the first workpiece against the second workpiece relatively while rotating the two workpieces relatively. The friction welding apparatus includes a high frequency induction heater for annealing the friction welded workpiece at a position adjacent to a welded portion thereof with high frequency induction heating.

This is a divisional of prior application Ser. No. 12/415,192, filed Mar. 31, 2009 to which priority under 35 U.S.C. §120 is claimed. This application also claims priority from Japanese Patent Application No. 2008-094930 filed on Apr. 1, 2008, the entire contents of which are incorporated herein by reference.

The present invention relates to a method and an apparatus of friction welding a pair of workpieces together by pressing one of the workpieces against the other workpiece while rotating the workpieces relatively.

When a workpiece joined by friction welding a pair of workpieces together is tested in tensile strength, the joined workpiece is ruptured generally in its heat-affected zone adjacent to a joint of the workpiece. When the joined workpiece is annealed, the heat-affected zone of the annealed workpiece is strengthened. Thus, when the annealed workpiece is tested in tensile strength, the annealed workplace is ruptured in its base portion. On the other hand, Japanese Unexamined Patent Application Publication No. 6-248350 discloses welding a pair of pipes together by other than the friction welding. In this publication, however, a pipe joined by welding a pair of pipes is heat-treated at a position adjacent to a joint of the pipe by high frequency induction heating.

It is common to use an electric furnace in annealing the joined workpiece. When the electric furnace anneals the joined workpiece made of carbon steel of S55C with a diameter of 12 mm, for example, it takes about two hours under a temperature of 650° C. In this case, the outer surface of the joined workpiece is oxidized and looks ugly. In view of the problems, the present invention is directed to a method and an apparatus of friction welding wherein the joined workpiece is increased in tensile strength and improved in appearance.

### SUMMARY OF THE INVENTION

In accordance with an aspect of the present invention, a friction welding method includes a step of friction welding a first workpiece and a second workpiece together by pressing the first workpiece against the second workpiece relatively while rotating the two workpieces relatively, and a step of annealing the friction welded workpiece at a position adjacent to a welded portion thereof with high frequency induction heating.

In accordance with another aspect of the present invention, there is provided a friction welding apparatus for friction welding a first workpiece and a second workpiece together by pressing the first workpiece against the second workpiece relatively while rotating the two workpieces relatively. The friction welding apparatus includes a high frequency induction heater for annealing the friction welded workpiece at a position adjacent to a welded portion thereof with high frequency induction heating.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a front view showing a friction welding apparatus;

FIG. 2 is a fragmentary view taken in the direction of the arrows along the line II-II of FIG. 1;

FIG. 3 is a flow chart showing a friction welding method;

FIG. 4 is a front view showing a friction welded workpiece;

FIG. 5 is a cross sectional view taken in the direction of the arrows along the line V-V of FIG. 4;

FIG. 6 is a front view showing a first workpiece and a second workpiece to be friction welded;

FIG. 7 is a graph showing a relationship between time and temperature in a step of high frequency induction heating; and

FIG. 8 is a view showing a relationship between time and controllable factors in a step of friction welding.

### DETAILED DESCRIPTION OF THE PREFERRED EMBODIMENTS

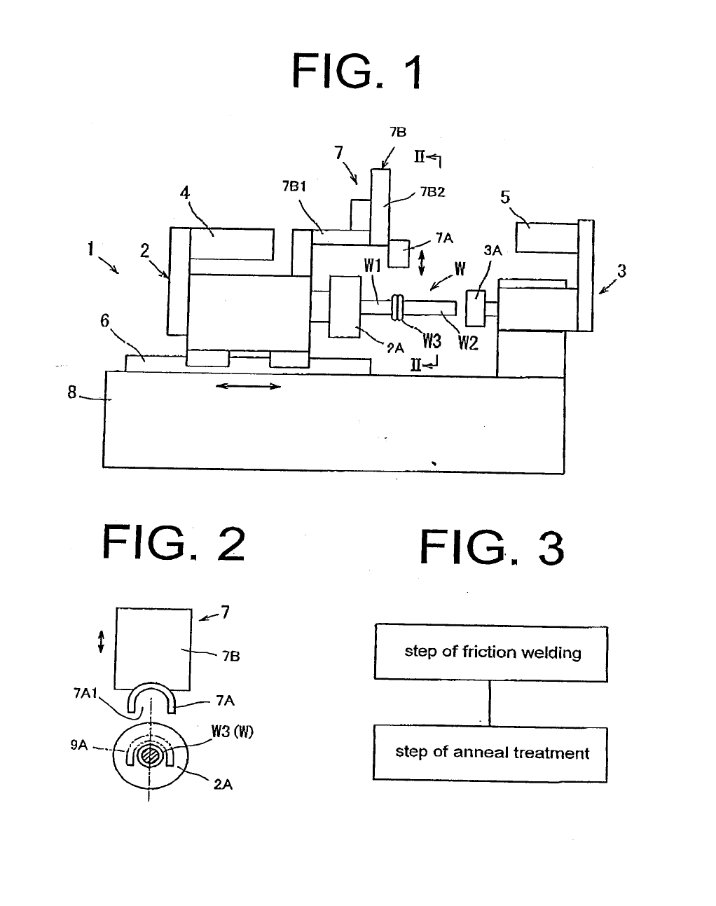

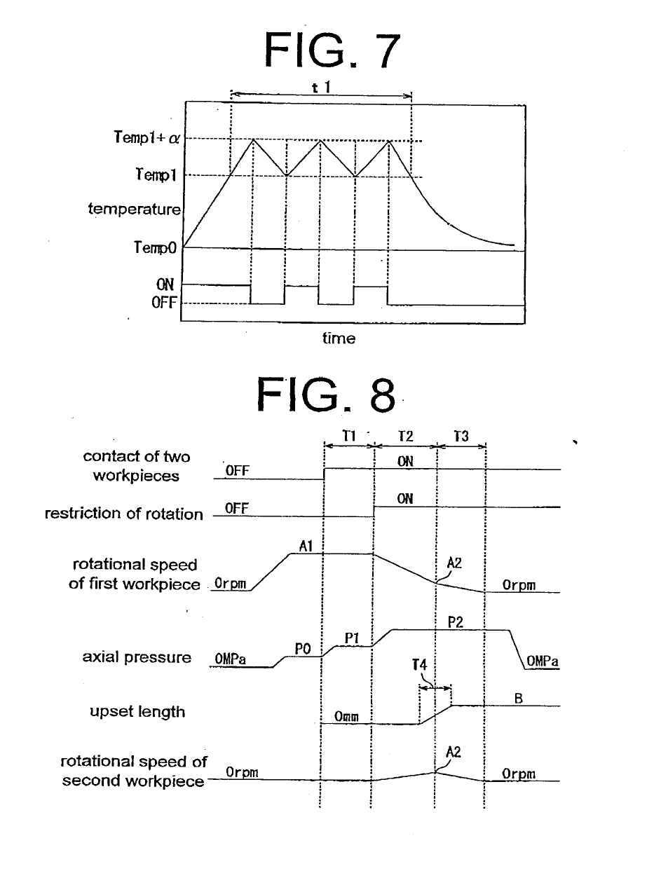

The following will describe an embodiment of the present invention with reference to FIGS. 1 through 8. Referring to FIG. 1, the friction welding apparatus 1 includes a bed 8, a first holder 2 (spindle unit) and a second holder 3. A guide 6 is mounted on the bed 8 at a position adjacent to the left end thereof. The first holder 2 is mounted movably relative to the guide 6 and moved along the guide 6 by thrust motor (not shown). The second holder 3 is mounted immovably on the bed 8 at the right end thereof. The first holder 2 has a chuck 2A for removably holding a first workpiece W1 in the form of a round bar. A motor 4 is mounted on the first holder 2 and operable to rotate the chuck 2A on the axis thereof. Likewise, the second holder 3 has a chuck 3A for removably holding a second workpiece W2 in the form of a round bar. A motor 5 is mounted on the second holder 3 and operable to rotate the chuck 3A on the axis thereof.

A high frequency induction heater 7 is mounted on the first holder 2 for induction heating a workpiece W. It is noted that the workpiece W is formed by friction welding the first workpiece W1 and the second workpiece W2 together. The high frequency induction heater 7 includes a coil 7A and a moving mechanism 7B. The moving mechanism 7B has a stationary part 7B1 mounted on the first holder 2 and a movable part 7B2 mounted so as to be vertically movable relative to the stationary part 7B1. The coil 7A is mounted on the movable part 7B2 at the lower end thereof. As shown in FIG. 2, the coil 7A is horseshoe-shaped and has an opening 7A1 that is opened downwardly. Therefore, when the coil 7A is moved toward the workpiece W by the moving mechanism 7B, the workpiece W is positioned into the opening 7A1, and the coil 7A surrounds a part of the outer periphery of the workpiece W.

To join the first workpiece W1 and the second workpiece W2 together by the friction welding apparatus 1, the step of friction welding is first performed and the step of anneal treatment is then performed as shown in FIG. 3. In the step of friction welding, to begin with, the first and second workpieces W1 and W2 are held by the chucks 2A and 3A, respectively. It is noted that FIG. 1 shows a state where the workpiece W is removed from the chuck 3A after the step of friction welding. Then, the first workpiece W1 is rotated on its axis with the chuck 2A by the motor 4 while the second workpiece W2 is held with the chuck 3A so as not to be rotated on its axis. Subsequently, the first holder 2 is moved toward the second holder 3 thereby to bring the first workpiece W1 into contact with the 20 second workpiece W2. Thus, frictional heat is generated between the first and second workpieces W1 and W2 thereby to frictionally weld the first and second workpieces W1 and W2 together.

Referring to FIG. 8, operation of the motor 4 is controlled by controller (not shown) thereby to rotate the first workpiece W1 at a rotational speed A1 ranging from 3300 to 10000 rpm, for example. If the rotational speed A1 is excessively low, seizure may occur at the outer peripheries of the first and second workpieces W1 and W2. Immediately after the occurrence of seizure, the two workpieces W1 and W2 may be ruptured due to torsion caused by relative rotation therebetween. In this case, there is possibility that heat generated by the rupture is rapidly increased and burr is formed.

Then, operation of the thrust motor is controlled to provide the first holder 2 with an axial pressure P0 thereby to move the first workpiece W1 toward the second workpiece W2. When the first workpiece W1 is brought into contact with the second workpiece W2 to generate frictional heat therebetween, operation of the thrust motor is controlled to provide the first holder 2 with an axial pressure P1. In this case, the first holder 2 is movably held in the direction away from the second holder 3 without moving toward the second holder 3 from the position where the first and second workpieces W1 and W2 are in contact with each other (refer to the period of time T1 of FIG. 8, which is a friction step). The axial pressure P1 is set, for example, in the range of 5 to 10 MPa. If the axial pressure P1 is excessively low, the friction step has a shortage of frictional heat. In the present embodiment, the friction step is finished before a burn-off length is formed. If the axial pressure P1 is excessively high, such a burn-off length is rapidly formed in the friction step thereby to form an excessive amount of burr. Providing a low axial pressure P1 and a high rotational speed A1 as described above, it is possible that the joint surfaces between the two workpieces W1 and W2 are heated in the friction step without forming such a burn-off length. The period of time T1 may be predetermined. If the two workpieces W1 and W2 are made of steel, the period of time T1 is set in the range of 0.05 second to 1 second.

After the friction step is finished, restricting the rotation of the first workpiece W1 is initiated. Then, operation of the thrust motor is controlled to provide an upset pressure P2 between the two workpieces W1 and W2. The upset pressure P2 is preferably set larger than the axial pressure P1 in the friction step by a factor of two to four times. The upset pressure P2 is set, for example, in the range of 10 through 30 MPa. When restricting the rotation of the first workpiece WI is initiated, operation of the motor 5 is controlled to allow the chuck 3A to be rotatable on its axis. Thus, the second workpiece W2 starts to freely run with the first workpiece W1 so that the two workpieces W1 and W2 rotate at the same speed after a lapse of time T1 and T2 (refer to the period of time T2 of FIG. 8, which is an upset step). Then, the two workpieces W1 and W2 are stopped rotating (refer to the period of time T3 of FIG. 8, which is also an upset process). Both of the time T2 and T3 are set, for example, in the range of 0.5 to 1 second. For a period of time T4 around the time when the relative rotation between the two workpieces W1 and W2 is zero, an upset length B is formed between the two workpieces W1 and W2. The upset length B is formed, for example, in the range of 0.05 to 0.2 mm.

After the step of friction welding, the step of anneal treatment is performed as shown in FIG. 3. In the step of anneal treatment, to begin with, the workpiece W is removed from the chuck 3A as shown in FIG. 1. Then, the coil 7A is moved close to a welded portion W3 of the workpiece W and high frequency current is flowed through the coil 7A. Then, operation of the motor 4 is controlled to rotate the workpiece W on its axis. Thus, high frequency induction heating is generated in the entirety of the outer periphery of the workpiece W adjacent to the welded portion W3. The high frequency induction heating is preferably initiated before the frictional heat generated in the step of friction welding is cooled completely. Thus, a necessary energy for high frequency induction heating is reduced.

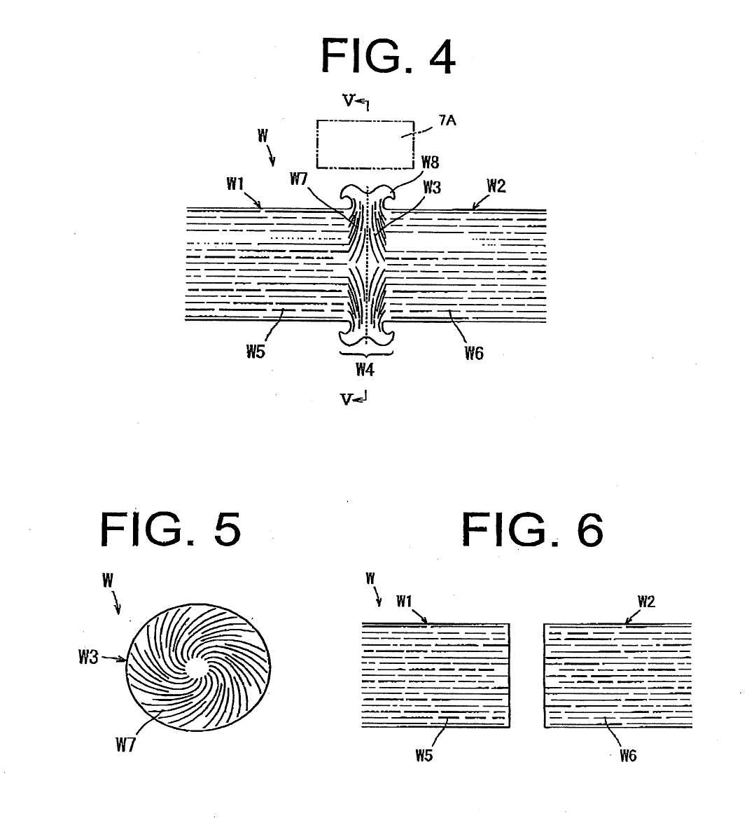

The two workpieces W1 and W2 are made of steel, including high carbon steel such as S55C and mild steel such as S15C. The two workpieces W1 and W2 are in the shape of solid or hollow rod or round bar. The two workpieces W1 and W2 are formed by extrusion molding as shown in FIG. 6, so that both workpieces W1 and W2 have fiber flows W5 and W6 (flow of metal structure) that extend axially, respectively. By friction welding the first and second workpieces W1 and W2 together, the welded portion W3 of the workpiece W has a fiber flow W7 (flow of metal structure) that extends radially and circumferentially as shown in FIGS. 4 and 5.

While conventional electric furnaces tend to heat the outer surface of the workpiece W, they hardly heat the center of the workpiece W. On the other hand, the high frequency induction heating has a property in which induction current tends to flow along a fiber flow. When the high frequency current is flowed through the coil 7A adjacent to the welded portion W3 of the workpiece W, therefore, high frequency induction heating tends to be generated at a position adjacent to the welded portion W3 along the fiber flow W7 in the radial direction of the workpiece W rather than in the axial direction thereof. Thus, temperature rises in a heat-affected zone W4 of the workpiece W adjacent to the welded portion W3 that is thermally affected in the step of friction welding, so that anneal treatment tends to be performed in the heat-affected zone W4. It is noted that burr W8 formed in the step of friction welding is eliminated from the workpiece W after or before the step of anneal treatment.

The anneal treatment was actually tested and its effect was confirmed. To begin with, the round bar made of S55C is friction welded by a method of low heat input to prepare eight specimens Nos. 1 to 8. Then, temperature of the outermost peripheral surface of the welded portion W3 of each specimen was controlled using a frequency for a period of retention time as shown in Table 1. The step includes a process of heating up for 5 seconds, a process of retaining a target temperature and a process of cooling.

TABLE 1

| | diameter | retention | temperature | frequency |
|---|---|---|---|---|
| No. | (mm) | time (s) | (° C.) | (KHz) |
| 1 | 12 | 10 | 300 | 10 |
| 2 | 12 | 10 | 400 | 10 |
| 3 | 12 | 10 | 500 | 10 |
| 4 | 12 | 10 | 600 | 10 |
| 5 | 12 | 0 | 600 | 10 |
| 6 | 17 | 10 | 300 | 24 |
| 7 | 17 | 10 | 400 | 24 |
| 8 | 17 | 10 | 400 | 144 |

Then, the workpiece which had not undergone the step of anneal treatment and the workpiece which had undergone the step of anneal treatment were tested in tensile strength. As a result, the workpiece which had not undergone the step of anneal treatment was ruptured at the heat-affected zone under a pressure of 756 MPa. On the other hand, the workpiece which had undergone the step of anneal treatment was ruptured at the base portion rather than at the heat-affected zone and its tensile strength was also increased. For example, the tensile strengths of the specimens Nos. 6 and 7 were 782 MPa and 773 MPa, respectively. Even when the outermost peripheral surface was kept at 300° C. for 10 seconds as in the case of the specimen No. 1, the specimen No. 1 was ruptured at the base portion to be found out that anneal treatment of the welded portion W3 was sufficient. Even when the retention time was zero second as in the case of the specimen No. 5, the specimen No. 5 was ruptured at the base portion to be found out that anneal treatment of the welded portion W3 was sufficient.

As described above, as shown in FIG. 3, the friction welding method includes the step of friction welding and the step of anneal treatment which performs anneal treatment by high frequency induction heating. Therefore, the workpiece W has an increased tensile strength by high frequency induction heating. The reason for the increased tensile strength is presumed as follows after deliberate consideration. Due to friction welding, microscopic region of which hardness is distinctly changed is developed adjacent to the outer peripheral portion of the welded portion W3 and it becomes an origin of rupturing in testing tensile strength. However, the microscopic region of which hardness is distinctly changed is gradated by anneal treatment of high frequency induction heating, so that the workpiece W is increased in tensile strength.

Anneal treatment according to the present embodiment is not conventionally performed and effectively applied to the workpiece W. More specifically, friction welding the first and second workpieces W1 and W2 together, the friction welded workpiece W has the fiber flow W7 that extends radially, which is not formed by other welding process. Because induction current tends to flow along such a fiber flow, high frequency induction heating tends to be generated at a position adjacent to the welded portion W3 along the fiber flow W7 in the radial direction of the workpiece W rather than in the axial direction thereof. Therefore, the microscopic region of which hardness is distinctly changed adjacent to the welded portion W3 is gradated efficiently by high frequency induction heating. The high frequency induction heating reduces an oxidized region of the workpiece W compared to the conventional electric furnace. Thus, annealed workpiece W is improved in appearance.

As shown in FIG. 6, the first and second workpieces W1 and W2 are in the form of a bar and have fiber flows W5 and W6 that extends axially. In the step of friction welding, as shown in FIG. 4, the fiber flow W7 extending radially is formed in the welded portion W3 of the workpiece W by pressing the first and second workpieces W1 and W2 against each other while rotating the two workpieces W1 and W2 on the axis thereof relatively. Therefore, the high frequency induction heating tends to be generated at a position adjacent to the welded portion W3 along the fiber flows W5, W6 and W7. Thus, the tensile strength of the workpiece W is effectively increased.

In the step of anneal treatment, the high frequency induction heating is executed so as to keep the outermost peripheral surface of the welded portion W3 at a temperature of 300 to 650° C. for 1 to 15 seconds. Therefore, the high frequency induction heating has lower preset temperature and shorter treating time than the conventional electric.

The step of friction welding preferably includes a friction step (T1) and an upset step (T2, T3) as shown in FIG. 8. Because the upset length is not formed in the friction step but is formed only in the upset step, the total upset length in the step of friction welding is reduced thereby to reduce burr formation. In addition, the time to perform the step of friction welding is extremely shortened. Because the heat generated is reduced and the workpiece W tends to be rapidly cooled, on the other hand, there is possibility that microscopic region of which hardness is distinctly changed may be developed adjacent to the outer peripheral surface of the welded portion W3. However, such a region is gradated by high frequency induction heating. Therefore, the tensile strength of the workpiece W is positively increased. Because the step of friction welding shown in FIG. 8 has less burr formation, high frequency induction heating is effectively applicable to the workpiece W even before burr is eliminated.

The friction welding apparatus 1 is provided with the high frequency induction heater 7 as shown in FIG. 1. Therefore, the friction welding apparatus 1 is made compact compared to the prior system where a friction welding apparatus and an electric furnace are separately provided.

The high frequency induction heater 7 has the coil 7A that is allowed to be disposed at a position adjacent to a part of the outer peripheral surface of the welded portion W3 of the workpiece W as shown in FIGS. 1 and 2. High frequency induction heating is generated in the entirety of the outer periphery of the welded portion W3 by flowing high frequency current through the coil 7A while rotating the workpiece W. Therefore, it is not necessary for the coil to surround the entire of the outer periphery of the workpiece W. This facilitates the operation of the heat treatment. Because the friction welding apparatus 1 includes the motor 4 for rotating the first and second workpieces W1 and W2 relatively, the motor 4 is used for rotating the workpiece W while high frequency current is flowed through the coil 7A.

The present invention is not limited to the above-described embodiment, but it may be modified as exemplified below.

(1) Although in the above-described embodiment the friction welding apparatus 1 is provided with the high frequency induction heater 7, the high frequency induction heater may be separately provided from the friction welding apparatus.

(2) Although in the above-described embodiment the coil 7A is horseshoe-shaped, a circular or linear coil may be arranged adjacent to and along a part of the outer peripheral surface of the workpiece W.

(3) In the above-described embodiment, the motor 4 rotates not only the first workpiece W1 in friction welding but also the welded workpiece W after friction welding. However, the motor 5 may rotate the workpiece W after the welded workpiece W is removed from the chuck 2A. Alternatively, it may be so arranged that one of the two motors is freed and the other is rotated without removing the workpiece W from the chucks. Both of the motors may be rotated at the same speed thereby to rotate the workpiece W.

(4) The step of friction welding is not limited to the step shown in FIG. 8, but it may be executed by a method of low heat input or a direct drive friction welding.

Therefore, the present examples and embodiments are to be considered as illustrative and not restrictive, and the invention is not to be limited to the details given herein but may be modified within the scope of the appended claims.

What is claimed is:

1. A friction welding method comprising the steps of:
friction welding a first workpiece and a second workpiece together by pressing the first workpiece against the second workpiece relatively while rotating the two workpieces relatively; and
annealing the friction welded workpiece at a position adjacent to a welded portion thereof with high frequency induction heating.

2. The friction welding method according to claim 1, further comprising the step of preparing each of the first workpiece and the second workpiece in the form of a bar before the step of friction welding, each of the first workpiece and the second workpiece has a fiber flow that extends in an axial direction of the bar, wherein the step of friction welding includes a step of forming a fiber flow that extends in a radial direction of the bar in the welded portion by pressing the first workpiece against the second workpiece relatively while rotating the two workpieces on an axis thereof relatively.

3. The friction welding method according to claim 1, wherein the first workpiece and the second workpiece are formed by extrusion molding.

4. The friction welding method according to claim 1, wherein the high frequency induction heating is performed by keeping temperature of an outermost peripheral surface of the welded portion in a range of 300 to 650° C. for 1 to 15 seconds.

5. The friction welding method according to claim 1, wherein the high frequency induction heating is performed while the friction welded workpiece is rotated.

6. The friction welding method according to claim 1, wherein the high frequency induction heating is initiated before frictional heat generated in the step of friction welding is cooled.

7. The friction welding method according to claim 1, wherein the step of friction welding comprises the steps of:
generating frictional heat by pressing the first workpiece against the second workpiece relatively while rotating the two workpieces relatively; and
forming an upset length between the two workpieces by restricting the relative rotation between the two workpieces and providing an upset pressure between the two workpieces before a burn-off length is formed between the two workpieces in the step of friction welding.
